(19) United States
(12) Patent Application Publication
(10) Pub. No.: US 2012/0166376 A1
(43) Pub. Date: Jun. 28, 2012

(54) INFORMATION CLASSIFICATION DEVICE, INFORMATION CLASSIFICATION METHOD, AND PROGRAM FOR CLASSIFYING INFORMATION

(76) Inventors: Iku Ohama, Osaka (JP); Hiromi Iida, Osaka (JP)

(21) Appl. No.: 13/393,840

(22) PCT Filed: Oct. 28, 2010
(86) PCT No.: PCT/JP2010/006360

§ 371 Date: Mar. 2, 2012

(30) Foreign Application Priority Data
Nov. 4, 2009 (JP) 2009-253529

(51) Int. Cl. G06F 15/18

(52) U.S. Cl. 706/20

(57) ABSTRACT

An information classification device of the present invention includes a classifying unit (3) classifying two or more content items into groups, each including a capturing time information item and a capturing location information item. The number of the groups is indicated in the number-of-groups information. Based on the capturing location information items, the classifying unit (3) merges each of the content items into the groups to generate first groups. In the case where there is a second group found among the generated first groups and including content items of which temporal continuity is not ensured, based on the capturing time information items, the classifying unit (3) divides the second group into sub-groups each including a content item of which temporal continuity is ensured, and adjusts the distance between each of two or more of the content items included in the sub-groups so that the sub-groups become distant from each other.

### TECHNICAL FIELD

The present information relates to information classification devices, information classification methods, and programs for classifying information and, in particular, to an information classification device, an information classification method and a program for classifying information which classify content items of still pictures and moving pictures captured by image capturing devices, such as a digital still camera, a camera-equipped cellular phone, and a camcorder.

### BACKGROUND ART

Digital image capturing devices for individual users, including a digital still camera, a camera-equipped cellular phone, and a camcorder, have rapidly become popular recently. Increase in the storage capacity of such image capturing devices allows the users to capture many content items. In contrast, however, the users have found it harder to watch all the content items within a limited amount of time. Such users feel difficulty in efficiently obtaining an overview of all the content items to watch a desired content item.

In order to solve the problem, one of the conventional techniques (See Patent Reference 1, for example) uses the Global Positioning System (GPS) information, which has recently been widely used, to automatically classify a large number of content items into events (a set of actions which a user can recognize). Thanks to the technique, the user can watch content items for each event.

It is noted that, in order to carry out the classification, the classifying technique defines the distance between content items based on meta-information to more closely relate the content items that position closer to each other. The meta-information includes capturing location information, such as a GPS information item assigned to each of content items and capturing time information indicating the time of capturing an image.

### CITATION LIST

### Patent Literature

### [PTL 1]

Japanese Unexamined Patent Application Publication No. 2008-77138

### SUMMARY OF INVENTION

### Technical Problem

The conventional technique fails to achieve both of the actions at the same time: To ensure the continuity of capturing times and to classify content items into groups each including content items captured geographically close to each other.

Suppose a user goes on a trip and captures images. When the user visits the same town a couple of times and captures images, the images are inevitably classified under a single event even though the captured images are temporally separated. In other words, the conventional classification method involves classifying the content items based on the capturing location information. Thus, unfortunately, the content items captured geographically close to each other are classified under a single event.

Thus, the user has to weigh the content items based on the capturing time information items to classify the content items into groups each including the content items captured geographically close to each other.

The classification result, however, varies according to the degrees to which the capturing time information items are weighed; that is, the temporal weight. In other words, the user arbitrarily classifies the weights of the capturing time information items. Thus, the resulting effect of the weighting can be either greater or smaller. When the effect of weighting with the capturing times is small, for example, the images captured at different times are inevitably classified under the same event (group) just because the images are captured geographically close to each other. When the effect of classifying the weights of the capturing times is great, in contrast, the classification process ends, failing to classify the images captured geographically close to each other under the same event (group). In other words, the images are left disorganized. Thus, in order to ensure the continuity of capturing times as well as to classify content items into groups each including the content items captured geographically close to each other, the user needs to carry out troublesome and arbitrary operations; that is, all to frequent adjustments of the degree of weighting.

The present invention is conceived in view of the above problems and has an object to provide an information classification device, an information classification method, and a program for classifying information items which can classify content items into groups so that each group includes the content items (i) that have temporal weights adjusted, freeing the user from adjusting the temporal weights himself or herself and (ii) that are captured geographically close to each other.

### Solution to Problem

In order to achieve the above object, an information classification device according to an aspect of the present invention includes: a storage unit which stores two or more content items and number-of-groups information, the content items each including (i) a capturing time information item indicating a capturing time of the content item and (ii) a capturing location information item indicating a capturing location of the content item, and the number-of-groups information indicating the number of groups into which the content items are classified; and a classifying unit which classifies the content items into the groups, the number of the groups being indicated in the number-of-groups information, wherein the classifying unit: generates, for each of the content items, a sequence information item indicating a sequence of capturing times of the content items, based on the capturing time information items; calculates a first distance between the capturing locations of each of the content items, based on the capturing location information items; sets each of the content items to a first group, and repeat merging groups of which distance therebetween is close to each other based on the calculated first distance so as to generate second groups, the number of the second groups being indicated in the number-of-groups information; checks, based on the sequence information items, temporal continuity of the content items included in each of the generated second groups; in the case where the temporal continuity of the content items included in each of the generated second groups is ensured, ends the classification, determining the second groups as the groups; and in the case where there is a third group found among the generated second groups and including content items of which temporal continuity is not ensured, (i) divides the third group into two or more sub-groups each including a content item of which temporal continuity is ensured and (ii) adjusts the first distance so that the sub-groups become distant from each other, so as to classify the content items into the groups, the number of the groups being indicated in the number-of-groups information, and the third group being divided based on the sequence information item of the content item included in the third group.

This structure allows the information classification device to carry out temporal weighting which involves dividing the third group into two or more sub-groups each including the content items of which temporal continuity is ensured, by adjusting the first distance. Hence, the present invention successfully provides the information classification device that can adjust a temporal weight, freeing the user from adjusting the temporal weight himself or herself, and classify content items into groups each including the captured content items geographically close to each other.

Here, in the case where there is the third group found among the generated second groups and including the content items of which temporal continuity is not ensured, the classifying unit may further repeat merging groups of which distance therebetween is close to each other based on the adjusted first distance so as to generate the second groups which are groups of the first groups, the number of the second groups being indicated in the number-of-groups information, and until the temporal continuity of the content items included in each of the second groups is ensured, the classifying unit may repeat generating the second groups from the first groups so as to classify the content items into the groups, the number of the groups being indicated in the number-of-groups information.

This structure provides an information classification device which achieves both of the actions at the same time: To ensure the continuity of capturing times and to classify content items into groups each including content items captured geographically close to each other.

It is noted that, instead of being provided as an apparatus, the present invention may also be proved as an integrated circuit including processing units which the apparatus has, as a method including the processing units, which the apparatus has, as steps, as a program which causes a computer to execute the steps, as information providing the program, and as data or a signal. The program, the information the data, and the signal may be distributed via a storage medium such as a CD-ROM and a communications medium such as the Internet.

### Advantageous Effects of Invention

The present invention successfully provides an information classification device, an information classification method, and a program for classifying information which can adjust a temporal weight, freeing the user from adjusting the temporal weight himself or herself, and classify content items into groups each including the content items captured geographically close to each other.

### BRIEF DESCRIPTION OF DRAWINGS

FIG. 1 exemplifies a user interface for an information classification device according to an embodiment of the present invention.

FIG. 2 exemplifies the user interface for the information classification device according to the embodiment of the present invention.

FIG. 3 exemplifies the user interface for the information classification device according to the embodiment of the present invention.

FIG. 4 shows the structure of the information classification device according to the embodiment of the present invention.

FIG. 5 exemplifies the data structure of a content information item according to the embodiment of the present invention.

FIG. 6 depicts a flowchart briefly showing an operation of the information classification device according to the embodiment of the present invention.

FIG. 7 depicts a flowchart showing detailed operational steps of classifying the content information items according to the embodiment of the present invention.

FIG. 8 depicts a flowchart showing detailed operational steps of updating a distance table according to the embodiment of the present invention.

FIG. 9 exemplifies the classification of the content items carried out by the information classification device according to the embodiment of the present invention.

FIG. 10 exemplifies the classification of the content items carried out by the information classification device according to the embodiment of the present invention.

FIG. 11 exemplifies the classification of the content items carried out by the information classification device according to the embodiment of the present invention.

FIG. 12 exemplifies the classification of the content items carried out by the information classification device according to the embodiment of the present invention.

FIG. 13 exemplifies the classification of the content items carried out by the information classification device according to the embodiment of the present invention.

FIG. 14 exemplifies the classification of the content items carried out by the information classification device according to the embodiment of the present invention.

FIG. 15 exemplifies capturing information items included in the content information items provided to a classifying unit of the information classification device according to the embodiment of the present invention.

FIG. 16 shows a relationship between a content item and the corresponding sequence number according to the embodiment of the present invention.

FIG. 17 exemplifies a distance table corresponding to the content information items according to the embodiment of the present invention.

FIG. 18 shows the result that the information classification device according to the embodiment of the present invention has assigned one group to each of the content items.

FIG. 19 shows the classification-in-progress of the content items carried out by the information classification device according to the embodiment of the present invention.

FIG. 20 exemplifies the case where the continuity of capturing times is not ensured in the progress of classifying the content items by the information classification device according to the embodiment of the present invention.

FIG. 21 shows how the information classification device according to the embodiment of the present invention adjusts a value of the distance table based on the sequence numbers of content items included in a group which does not maintain the continuity of capturing times.

FIG. 22 shows the result of the classification when the content items according to the embodiment of the present invention are completely classified.

FIG. 23 shows the case where the continuity of capturing times is maintained when the content items according to the embodiment of the present invention are completely classified.

FIG. 24 exemplifies how the content items according to the embodiment of the present invention are displayed.

FIG. 25 shows the structure of another information classification device according to the embodiment of the present invention.

### DESCRIPTION OF EMBODIMENT

### Embodiment

Described hereinafter is an information classification device according to the embodiment of the present invention, with reference to the drawings.

(1-1. Overview)

Described first is the overview of the information classification device of the present invention.

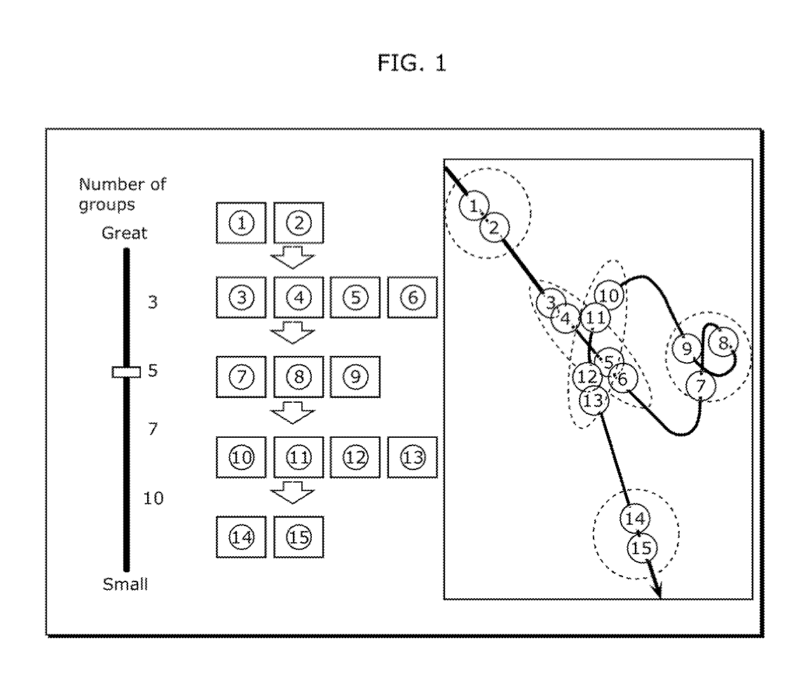

FIGS. 1 to 3 exemplify a user interface for the information classification device according to the embodiment of the present invention.

The information classification device according to the embodiment ensures the continuity of capturing times as well as classifies content items into groups each including the content items captured geographically close to each other. Thus, the apparatus allows the user to watch content items captured, for example, in a trip for each event that temporally weighed and classified and that recognizable to the user, freeing the user from adjusting temporal weight himself or herself.

Moreover, the user can freely select the number of groups into which the information classification device of the embodiment classifies. Thus, the user can watch the content items for each set of events of any given granularity (for any given number of groups). Accordingly, the user can browse many content items more efficiently. Furthermore, the continuity of capturing times is ensured of a content items group, such as pictures, and the content items in each group are temporally close to each other, as well. Thus, even though there is a content item captured at a distant capturing time from among the content items captured geographically close to each other, such a content item is classified into another group and displayed. Thus, the user can watch the content items in a manner that the user can easily remember what happened in the past.

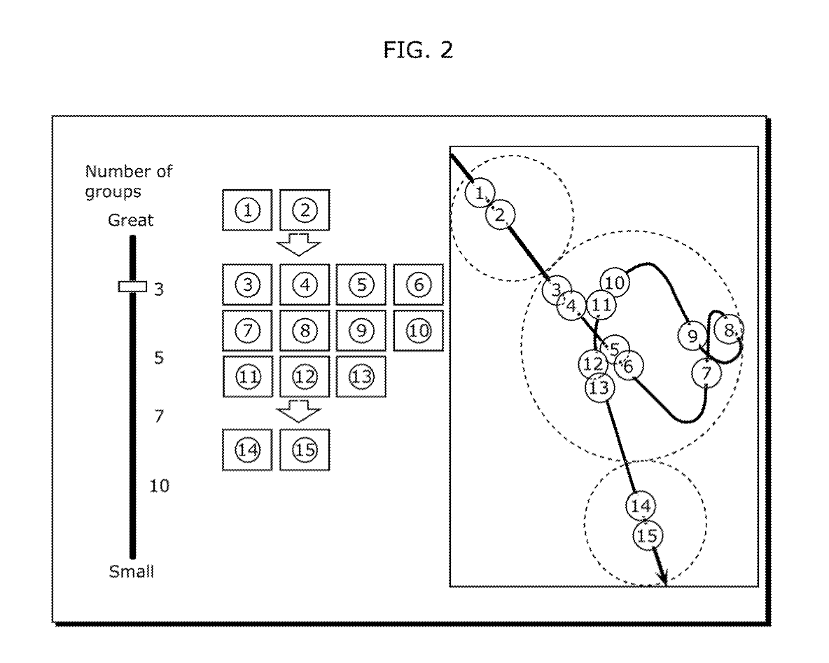

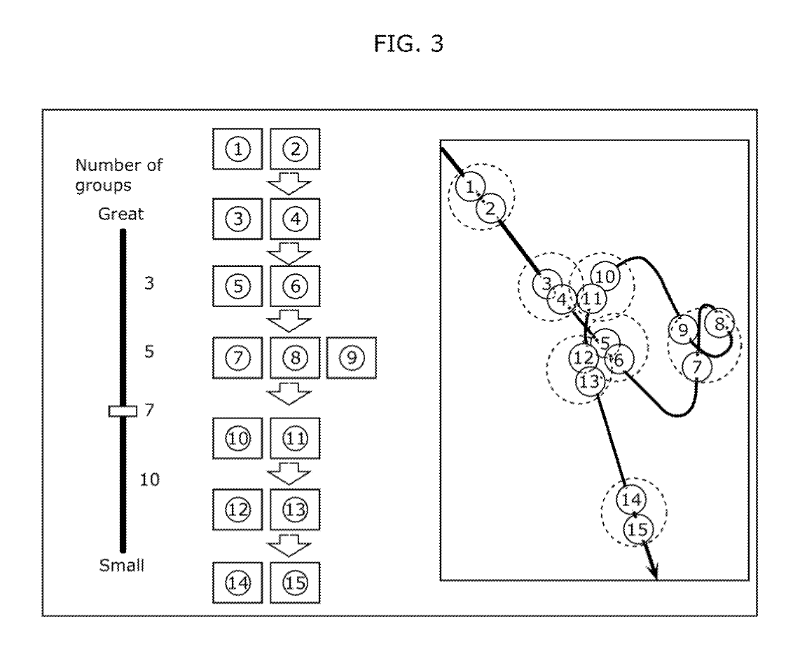

Here, FIGS. 2 and 3 respectively exemplify the cases where, for example, the user causes the information classification device to classify and display the content items into three groups (Granularity 3) and seven groups (Granularity 7). In either case, the content items to be displayed are ensured to have the continuity of capturing times and classified to be displayed into groups each including the content items captured geographically close to each other.

It is noted that, in the Specification, the content items captured geographically close to each other are located relatively near with each other among content items in terms of the physical distance between the captured content items.

(1-2. Structure)

Described next is the structure of the information classification device of the present invention.

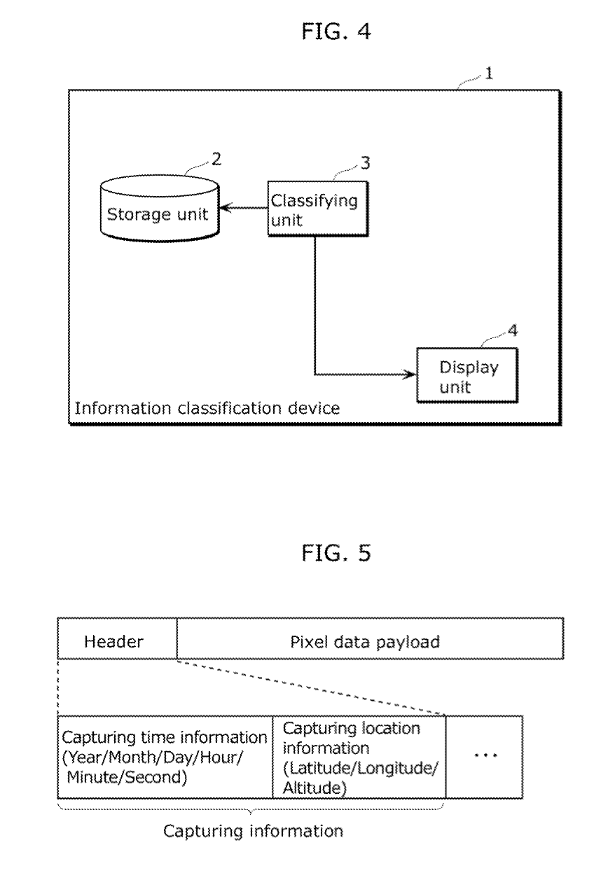

FIG. 4 shows the structure of the information classification device according to the embodiment of the present invention. As FIG. 4 shows, an information classification device 1 according to the embodiment includes a storage unit 2, a classifying unit 3, and a display unit 4.

The storage unit 2 stores two or more content items and the number-of-groups information. Each of the content items includes capturing time information indicating the time of capturing, and capturing location information indicating the location of capturing. The number-of-groups information indicates the number of groups to be classified into. Specifically, the storage unit 2 may be a magnetic disc apparatus such as an HDD, and a memory card, and may store information on content item (content information item information) captured by an image capturing apparatus, such as a digital camera and a camcorder. Furthermore, the storage unit 2 stores classification information indicating the result of classification carried out by the classifying unit 3.

Here, the content information item is the information on the content item, and includes (i) the pixel data of a captured content item, (ii) the capturing time information indicating the time when the content is captured and (iii) the capturing location information such as GPS information for specifying the location where the content item is captured. It is noted that a typical content item is a still picture, such as a photo and a moving picture. Instead, the content item may also include at least one of the capturing time information and the capturing location information. In other word, for example, the content item may be (i) a document file including date and time of creation and location and (ii) a destination (route) including (a) the date and time when a moving object, such as a vehicle, moves and (b) the location where the moving object goes. Furthermore, the classification information is calculated by the after-described classifying unit 3, and includes information used for specifying which content information item belongs to which group.

FIG. 5 exemplifies the data structure of a content information item. As FIG. 5 shows, the header of the content-information item stores (i) the capturing time information indicating the time (Year/Month/Day/Hour/Minute/Second) when the content item is captured and (ii) the capturing location information indicating the location (Latitude/Longitude/Altitude) where the content item is captured (hereinafter the capturing time information and the capturing location information are referred to collectively as capturing information). Following the header, a pixel data payload is provided to store information on luminance for each of the pixels that the content item consists of. The Exchangeable Image File Format (Exif) is one of the formats that allow such capturing information to be stored. Thus, a JPEG file and an MPEG file which are compliant with the Exif are used as the content information item. As a matter of course, the present invention shall not limit the sequences in the content information item, such as the sequence of the capturing time information and the capturing location information and the sequence of the header and the pixel data payload, as shown in FIG. 5.

The classifying unit 3 classifies content items into groups. Here, the number of the groups is indicated in the number-of-groups information. Specifically, first, the classifying unit 3 generates, for each content item, a sequence information item indicating the sequence of capturing times of the content items based on two or more of the capturing time information items. Then, based on the capturing location information items, the classifying unit 3 calculates a first distance between the capturing locations of each of the content items. Next, the classifying unit 3 sets each of the content items to a first group, repeats merging groups of which distance therebetween is close to each other based on the calculated first distance so as to generate second groups which are groups of the first groups, the number of the generated second groups being indicated in the number-of-group information. Then, based on the sequence information items, the classifying unit 3 checks the temporal continuity of the content items included in each of the generated second groups. In the case where the temporal continuity of the content items included in each of the generated second groups is ensured, the classifying unit 3 ends the classification, determining that the number of the generated second groups equals the number of groups indicated in the number-of-groups information. In contrast, suppose the case where there is a third group found among the generated second groups and including the content items of which temporal continuity is not ensured. Then, based on the sequence information of the content items included in the third groups, the classifying unit 3 divides the third group into two or more sub groups each including the content items of which temporal continuity is ensured, and adjusts the first distance so that the divided sub groups become geographically distant from each other. In other words, by adjusting the first distance so that the sub groups become geographically distant from each other, the classifying unit 3 carries out temporal weighting which involves dividing the third group into two or more sub groups each including the content items of which temporal continuity is ensured. Then, in the case where there is the third group found among the generated second groups and including the content items of which temporal continuity is not ensured, the classifying unit 3 repeats merging the groups of which distance therebetween is close to each other based on the adjusted first distance so as to generate the second groups which are groups of the first groups, the number of generated second groups being indicated in the number-of-group information. The classifying unit 3 repeats generating the second groups until the number of the second groups equals the number of groups indicated in the number-of-groups information so that the content items are separated into the second groups, the number of second groups being indicated in the number-of-groups information. Then, until the temporal continuity of the content items included in each of the second groups is ensured, the classifying unit 3 repeats generating the second groups from the first groups in order to classify the content items into the groups, the number of the groups being indicated in the number-of-groups information. The classifying unit 3 stores the classification result in the storage unit 2.

In other words, the classifying unit 3 calculates the classification information based on the capturing information extracted from the content information stored in the storage unit 2 and the number-of-groups information indicating that the content items are classified into how many groups. Then, the classifying unit 3 stores the resulting classification information into the storage unit 2.

Here, the classification information is for specifying which content information item belongs to which group. The classification information is used for displaying, on the display unit 4, the result of classifying the content items into the groups the number of groups being equal to the number indicated in the number-of-groups information. The number-of-groups information may be either a numeric value entered by the user or a predetermined numeric value based on a factor such as the size of the monitor of the display unit 4. It is noted that, typical number-of-groups information is predetermined by the user before the classifying unit 3 calculates the classification information, and is stored in the storage unit 2. The description hereinafter is on the premise that the user determines the number-of-groups information; however, such a premise shall not limit the description below. For example, the classification technique may involve storing into the storage unit 2 two or more prospective number-of-groups information items (number-of-groups information candidates), and causing the classifying unit 3 to calculate a classification information candidate corresponding to each of the number-of-groups information candidates, and to calculate a score indicating a likelihood for each of classification information candidates. Here, the number-of-groups information candidate having the highest score and the corresponding classification information candidate may respectively be used as the number-of-groups information and the classification information which is calculated by the classifying unit 3. The statistic score may be calculated based on, for example, the Bayesian Information Criterion (BIC) and the Akaike Information Criterion (AIC).

The display unit 4 displays the content information items on a group basis according to the content information and the classification information stored in the storage unit 2.

That is about the structure of the information classification device 1.

(1-3. Operation)

Described next is the operation of the information classification device of the present invention.

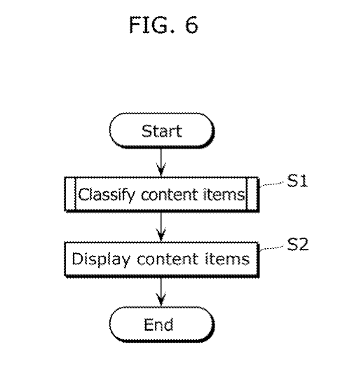

FIG. 6 depicts a flowchart briefly showing an operation of the information classification device 1 according to the embodiment of the present invention.

First, the classifying unit 3 classifies content items (S1). Specifically, upon receiving the content information items stored into the storage unit 2, the classifying unit 3 classifies the content information items using the after-described technique, and stores into the storage unit 2 the classification information obtained as the result of the classification.

Hereinafter, classifying content items means to classify the content items into groups the number of the groups being indicated in the number-of-groups information. By assigning a corresponding one of the groups to each content item, the classification processing makes the content items identifiable to which content belongs to which group.

Then, the display unit 4 displays the content items (S2). Specifically, the display unit 4 receives the content information item and the classification information item stored into the storage unit 2, and displays the content information item for each group.

That is the operation of the information classification device 1.

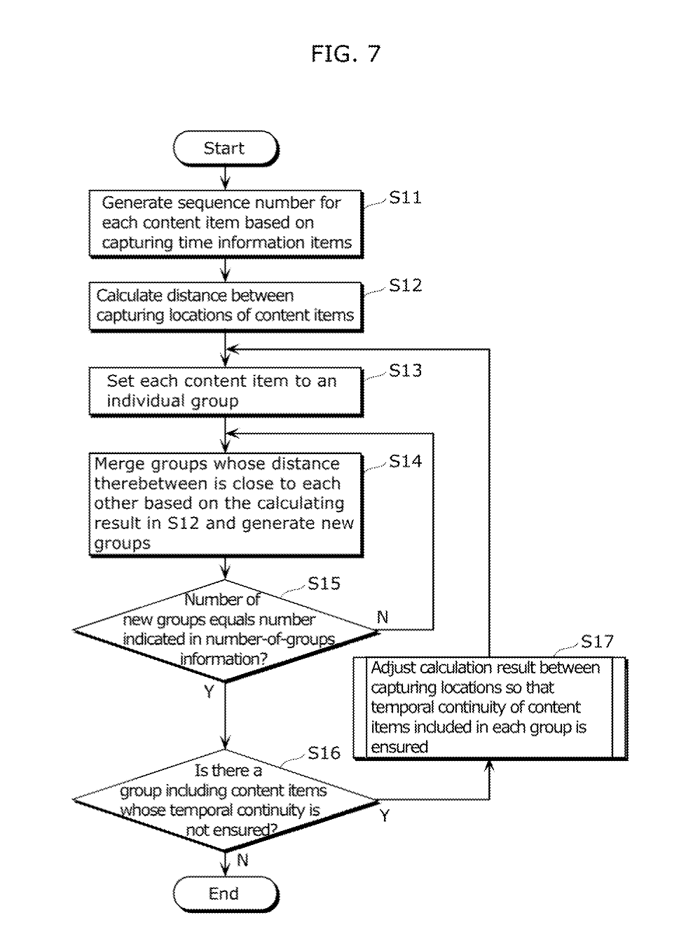

FIG. 7 depicts a flowchart showing detailed operational steps of classifying (S1) the content information items.

First, based on two or more capturing time information items, the classifying unit 3 generates a sequence information item for each in content item. The sequence information item indicates the sequence of capturing times of the content items. Specifically, based on the capturing time information items, the classifying unit 3 generates a sequence number for each of the content items (S11). With reference to the capturing time of each content item, the classifying unit 3 assigns to each content item the sequence number indicating temporal order showing when the content item is captured.

Then, based on the capturing location information items, the classifying unit 3 calculates the first distance between the capturing locations of the content items. Specifically, the classifying unit 3 calculates the distance between the capturing locations of the content items (S12). Here, the classifying unit 3 calculates the physical distance between the capturing locations for all the combinations of each of the content items.

Next, the classifying unit 3 sets each of the content items as a single first group. In other words, the classifying unit 3 sets each content item to an individual group (S13).

In the after-described processing, the classifying unit 3 recursively merges the groups with each other in order to classify the content information items (S14 and S15). In other words, the classifying unit 3 sets each of the content items to a single first group, repeats merging the groups of which distance therebetween is close to each other based on the calculated first distance, and generates the second groups, the number of the second groups being indicated in the number-of-group information. Specifically, the classifying unit 3 first merges the groups of which distance therebetween is close to each other based on the calculation result in S12, and generates new groups (S14). More specifically, the classifying unit 3 calculates the distance between each of the groups based on the values of the distance between the capturing locations of each of the content items. Then, the classifying unit 3 merges two groups into one. Here, the distance between the two groups is closest to each other. Next, the classifying unit 3 determines whether or not the number of the new groups generated in S14 equals the number indicated in the number-of-groups information (S15). Here (S15), in the case where the number of the new groups equals the number indicated in the number-of-groups information (S15: Y), the subsequent processing is executed. In the case where the number of the new groups is greater than the predetermined number (S15: N), the classifying unit 3 again executes the merging processing (S14). It is noted that the number of content items indicated in the number-of-groups information has to be equal to or smaller than all the number of the content items.

Then, based on the sequence information, the classifying unit 3 checks the temporal continuity of the content items included in each of the generated second groups. Specifically, in each of the groups, the classifying unit 3 refers to the sequence numbers of the content items included in each group in order to determine whether or not there is a group, among the groups, including content items of which temporal continuity is not ensured (in other words, the sequence numbers are interrupted) (S16).

In the case where the temporal continuity of the content items included in each of the generated second groups is ensured, the classifying unit 3 sets the second groups to desirably classified groups, and ends the classification. Specifically, the classifying unit 3 ends the process (the end of processing in S1 in FIG. 6) in the case where the temporal continuity of the capturing times is maintained among all the groups (S16: N). Once the processing in S1 ends, the information classification device 1 continuously executes the processing in S2 shown in FIG. 6.

In contrast, suppose the case where there is a third group found among the generated second groups and including the content items of which temporal continuity is not ensured; that is, the case where there is a group of which temporal continuity of the capturing times is not ensured (S16: Y). The classifying unit 3 adjusts the calculation in result between the capturing locations so that the temporal continuity of the content items in each of the groups is ensured by the after-described technique (S17). Then, the classifying unit 3 returns to the processing of assigning one group to each of the content items (S13), and executes the classification again.

That is how the classifying unit 3 of the information classification device 1 classifies the content information items.

It is noted that the group of which temporal continuity of the capturing times is ensured means that the group consists only of the content items of which assigned sequence numbers are uninterrupted.

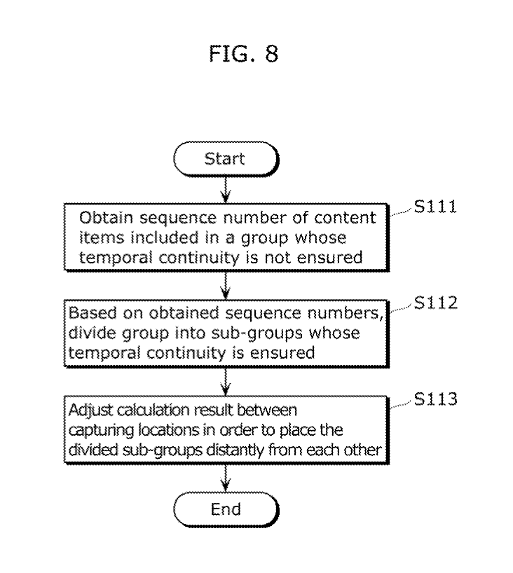

FIG. 8 depicts a flowchart showing detailed operational steps of updating a distance table. In other words, FIG. 8 depicts a flowchart showing detailed operational steps executed by the classifying unit 3 adjusting the calculation result between the capturing locations (S17). Here, the adjustment ensures the temporal continuity of the content items included in each group.

First, suppose the case where there is the third group, among the generated second groups, including the content items of which temporal continuity is not ensured; that is, the case where there is a group of which temporal continuity of the capturing times is not ensured (S16: Y). The classifying unit 3 obtains the sequence numbers of the content items included in the group of which temporal continuity is not ensured (S111). Specifically, in the case where the classification unit 3 finds a group of which temporal continuity of the capturing times is not ensured in the processing (S16) determining whether or not the temporal continuity of the capturing times is ensured, the classifying unit 3 obtains the sequence numbers of all the content items included in the found group. It is noted that in the case where the classifying unit 3 finds two or more of the groups of which temporal continuity of the capturing times is not ensured, the classifying unit 3 executes the processing in FIG. 8 on each of the groups.

Then, based on the sequence information on the content items included in the third group, the classifying unit 3 divides the third group into two or more sub-groups including the content items of which temporal continuity is ensured. Specifically, based on the obtained sequence numbers, the classifying unit 3 divides the third group into two or more of the sub-groups of which temporal continuity is ensured (S112).

Then, the classifying unit 3 adjusts the first distance in order to place divided sub-groups distantly from each other. Specifically, the classifying unit 3 adjusts the calculation result between the capturing locations in order to place the divided sub-groups distantly from each other for each of all the combinations of the sub-groups obtained in the previous processing (S113). More specifically, the classifying unit 3 adjusts the distance between the capturing locations of the content items which (i) are included in the sub-groups so that the distance increases (becomes greater) between the sub-groups calculated based on the calculation result in S12 and (ii) define the distance between the sub-groups. In the processing, the classifying unit 3 substitutes (i) adjusting of the distance between the capturing locations of the content items which define the distance between the sub-groups for (ii) temporally weighting the content items.

That is how the classifying unit 3 of the information classification device 1 updates the distance table.

Then, the classifying unit 3 of the information classification device 1 goes back to the flow in FIG. 6, using the calculation result adjusted in S113. In other words, the processing proceeds to S13 shown in FIG. 6, and the classifying unit 3 executes the classification again. Specifically, in the case where there is a third group found among the generated second groups and including the content items of which temporal continuity is not ensured, the classifying unit 3 further repeats merging the first groups of which distance therebetween is close to each other based on the adjusted first distance, and generates the second groups which are groups of the first groups, the number of the second groups being indicated in the number-of-group information. Then, until the temporal continuity of the content items included in each of the second groups is ensured, the classifying unit 3 repeats generating the second groups from the first groups.

The classifying unit 1 classifies the content items into groups, the number the groups being indicated in the number-of-groups information.

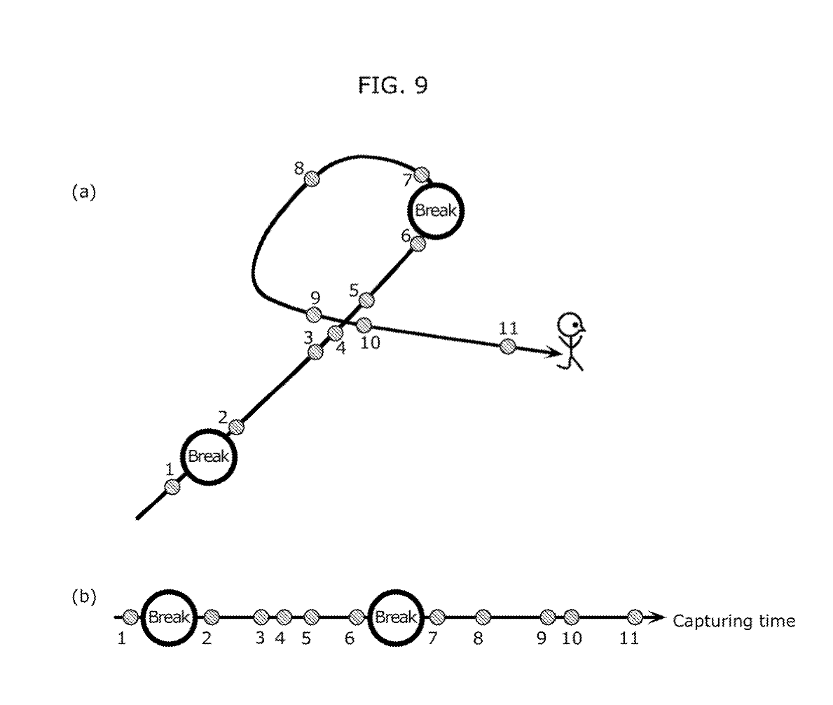

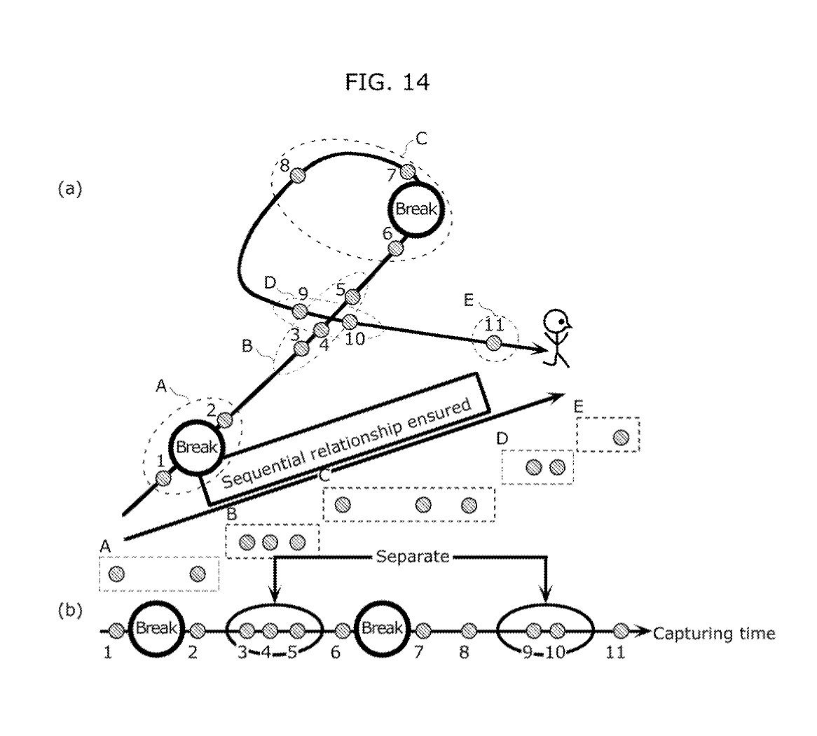

Exemplified here is how the information classification device 1 shown in FIGS. 7 and 8 classifies the content items. FIGS. 9 to 14 exemplify the classification of the content items carried out by the information classification device 1 according to the embodiment of the present invention. The example in FIGS. 9 to 14 shows how the information classification device 1 classifies 11 pictures, adding temporal weights to the pictures in a step-by-step manner. Here, the 11 pictures are the content items that the user has captured, taking breaks in between. It is noted that FIGS. 9 to 14 (b) are the same.

In principle, the user is to capture 11 pictures, taking breaks in between. FIG. 9(a) schematically shows the capturing locations where the user captured the pictures, as well as his or her route. After capturing the pictures, the user causes the information classification device 1 to classify the pictures as described below.

As shown in FIG. 9 (b), the classifying unit 3 first generates sequence information items (sequence numbers) 1 to 11 indicating the sequence of the capturing times of the 11 pictures, and assigns each of the sequence information items to a corresponding one of the pictures. This operation is equivalent to the processing in S 11: Based on the capturing time information items, the classifying unit 3 in generates for each content item the sequence information item indicating the sequence of capturing times of the content items.

Then, based on the information on the capturing locations of the 11 pictures (pictures 1 to 11 with sequence numbers 1 to 11 assigned to), the classifying unit 3 calculates the distance between each of the capturing locations, and hold the value of each distance in, for example, a table. This operation is equivalent to the processing in S 12: Based on the capturing location information items, the classifying unit 3 calculates the first distance between the capturing locations of each of the content items.

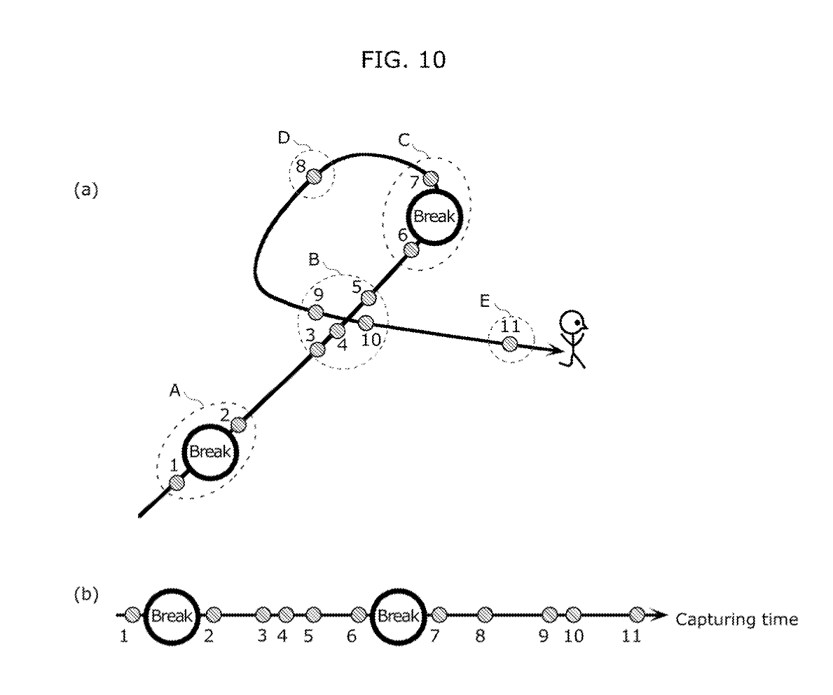

Next, the classifying unit 3 sets each of the pictures sequentially numbered 1 to 11 as a single group (S13), repeats merging the groups of which distance therebetween is close to each other based on the calculated distance between each of the capturing locations of the pictures sequentially numbered 1 to 11, and generates the second groups, the number of the second groups (five groups) being indicated in the number-of-group information. Then, as shown in FIG. 10(a), the classifying unit 3 uses the capturing location information items to merge the pictures 1 to 11 into groups A to E, the number of which is indicated in the number-of-group information (S14).

Next, based on the sequence information items on the pictures (pictures 1 to 11), the classifying unit 3 checks the temporal continuity of the picture content items included in each of the generated groups A to E (S15).

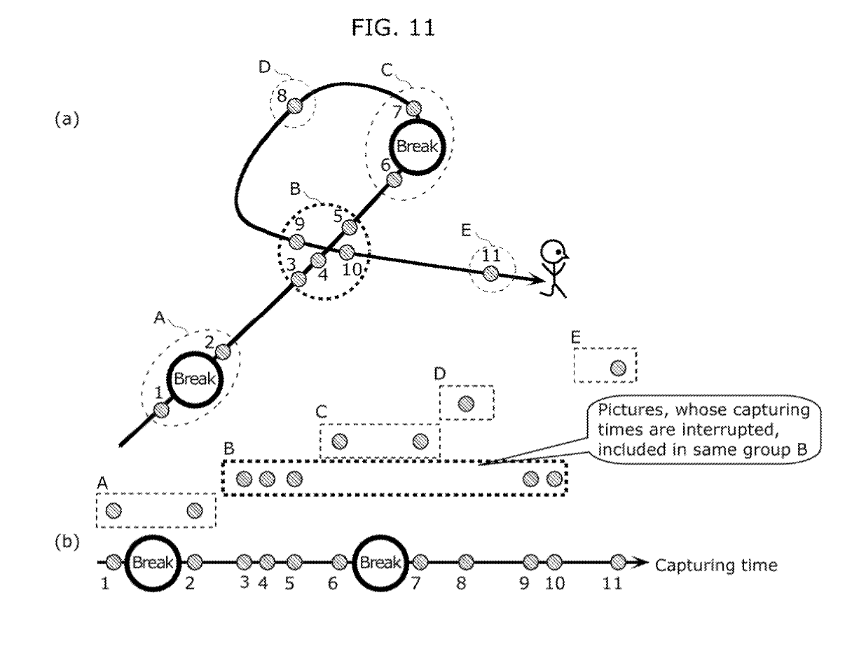

Here, based on the sequence information items of the pictures, the classifying unit 3 checks the temporal continuity of the pictures included in each of the generated groups A to E (S16). Then, as shown in FIG. 11(a), the classifying unit 3 confirms that the group B includes the pictures of which temporal continuity is not ensured (the sequence numbers are interrupted) (S16: Y). Specifically, the classifying unit 3 confirms that the group B includes pictures 5 and 9 of which sequence information items (sequence numbers) are interrupted.

Thus, the classifying unit 3 obtains the sequence information items (sequence numbers) of the pictures included in the group B of which temporal continuity is not ensured (S17 and S111).

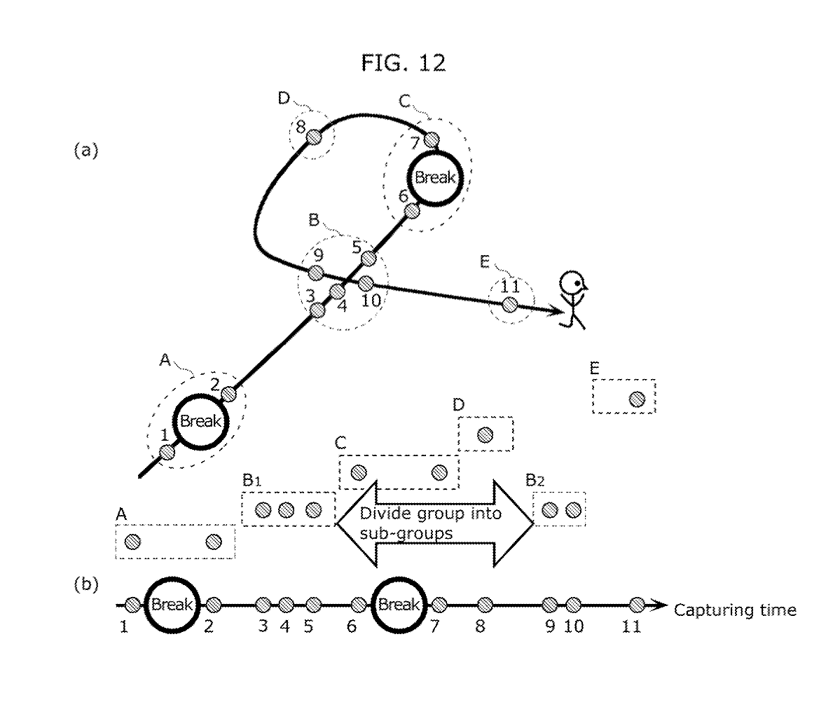

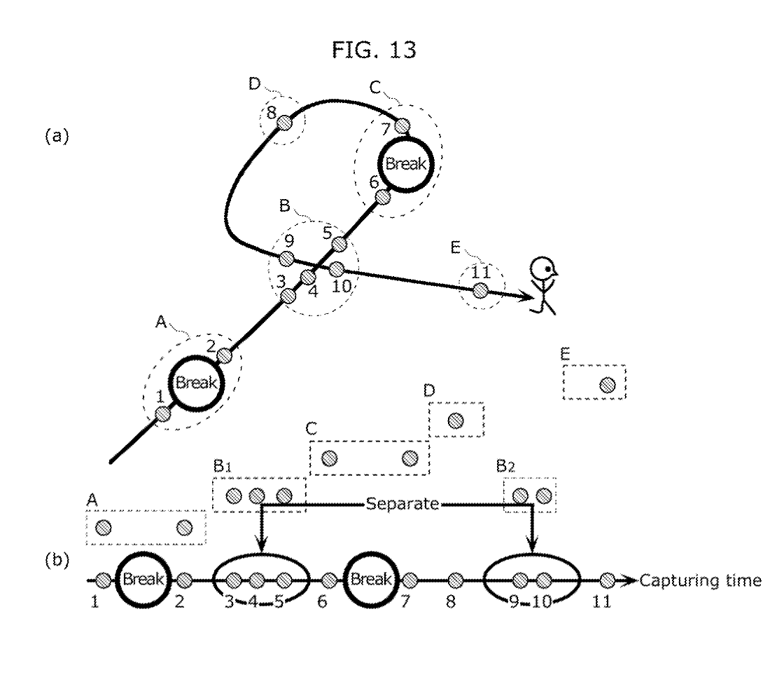

Next, as shown in FIG. 12(a), the classifying unit 3 uses the obtained sequence information items (sequence numbers 1 to 11) to divide the group B into sub-groups B1 and B2 (sequence numbers 9 and 10) of which temporal continuity is ensured (the sequence numbers are not interrupted) (S17 and S112). Here, the sub-group B1 includes the sequentially numbered pictures 3 to 5, and the sub-group B2 includes the sequentially numbered pictures 9 and 10. Then, as shown in FIG. 13(a), the classifying unit 3 adjusts the distance between the sub-group B1 and B2 in order to place the divided sub-groups B1 and B2 distantly from each other (so that the sub-groups B1 and B2 exist separately) (S17 and S113). Specifically, the classifying unit 3 adjusts the distance between the capturing locations of the held pictures; that is, the distance between (i) sequentially numbered pictures 3 to 5 and (ii) the sequentially numbered pictures 9 and 10. Thus, the classifying unit 3 groups the pictures, of which sequence information items (sequence numbers) are interrupted in the group B, into separate groups; the sub-group B1 including the sequentially numbered pictures 3 to 5 and the sub-group B2 including the sequentially numbered pictures 9 and 10.

Then, based on the adjusted calculation result, the classifying unit 3 repeats classifying processing at S13 in order to distantly place the sub-groups B1 and B2 into which the classifying unit 3 divides in the processing in S113 (so that the sub-groups B1 and B2 exist separately). Then, until the temporal continuity (the temporal continuity of the sequence numbers) of the pictures included in the five groups A to E is ensured, the classifying unit 3 repeats the processing S13 through S17.

Hence, the information classification device 1 successfully classifies the pictures into the groups A to E that are temporally weighed and indicated in the number-of-groups information.

Detailed hereinafter is the flow of processing in the information classification device 1, taking a specific content information item as an example.

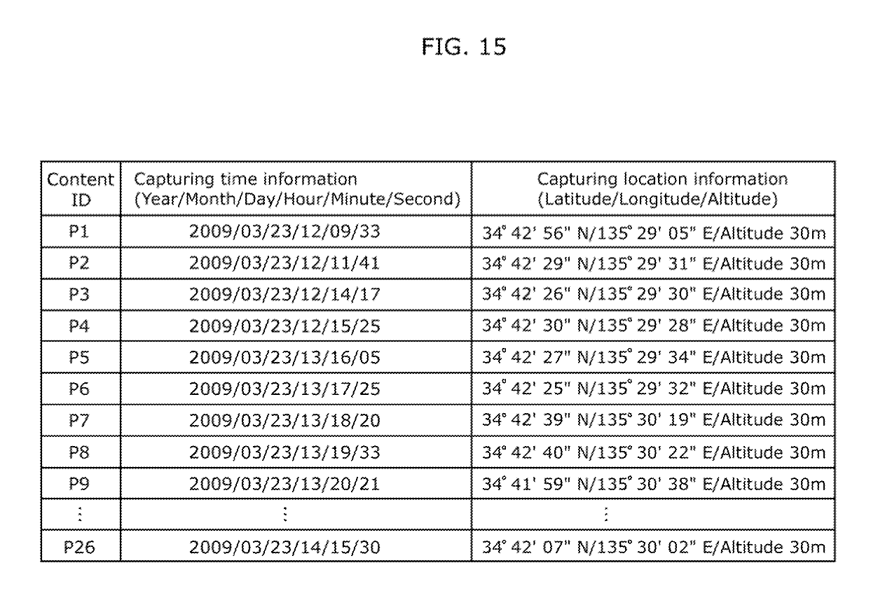

FIG. 15 exemplifies capturing information items included in the content information items provided to the classifying unit 3 of the information classification device 1 according to the embodiment of the present invention. As shown in FIG. 15, the description hereinafter is made on the premise that 26 content information items are provided from the storage unit 2 to the classifying unit 3 of the information classification device 1 according to the embodiment. Each of the content information items has a content ID (P1 to P26, for example) assigned to. For example, FIG. 15 shows that the content information item of which content ID is P1 indicates the following: A content item is captured at the time of 12:09:33, Mar. 23, 2009, at the position of 34° 42′ 56″ N and 135° 29′ 05″ E, and an altitude of 30 meter.

First, the classifying unit 3 classifies content items (S1). Specifically, the classifying unit 3 extracts the capturing time information and the capturing location information from the content information items indicated in FIG. 15. For the content information item P1, the following is extracted; 12:09:33, Mar. 23, 2009 as a capturing time information item T1, and 34° 42′ 56″ N, 135° 29′ 05″ E, and an altitude of 30 meter as a capturing location information item L1. Then, based on the capturing information shown in FIG. 15, the classifying unit 3 classifies the content information items using the after-described technique, and stores the resulting classification information into the storage unit 2.

Detailed hereinafter is the processing (S1) for classifying the content items.

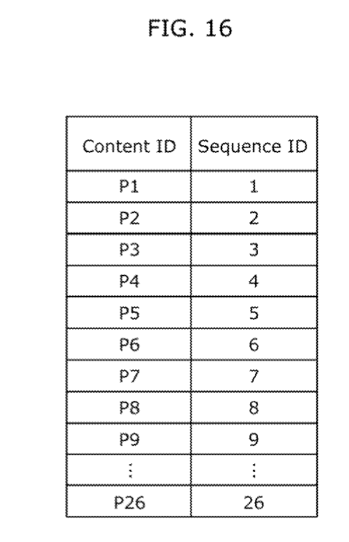

First, based on the capturing time information items, the classifying unit 3 generates a sequence number for each of the content items (S11). Specifically, with reference to the capturing time of each content item, the classifying unit 3 assigns to each content item the sequence number indicating temporal order at which the content item is captured. More specifically, with reference to the capturing time information items of the content items P1 to P26, the classifying unit 3 assigns numbers in the order of capturing times as shown in FIG. 16. Here, FIG. 16 shows the corresponding relationship between the content items P1 to P26 and the sequence numbers.

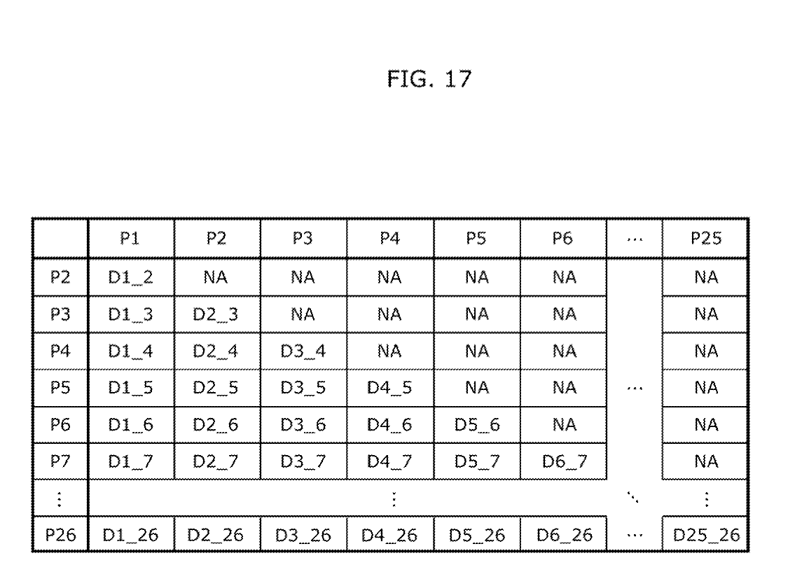

Next, the classifying unit 3 calculates the distance between each of the capturing locations of the content items (S12). Specifically, the classifying unit 3 calculates the physical distance between the capturing locations for all the combinations of each of the content items, and creates the distance table holding the calculated values of the distance as shown in FIG. 17. Here, FIG. 17 exemplifies a distance table corresponding to the content information items P1 to P26. In FIG. 17, Da_b is the value of the distance between two content information items Pa and Pb. It is noted that the values of the distance is two-dimensionally listed as shown in FIG. 17; instead, any other technique may be used as far as the technique can express the physical distance between the capturing locations of any given two content items, as a matter of course.

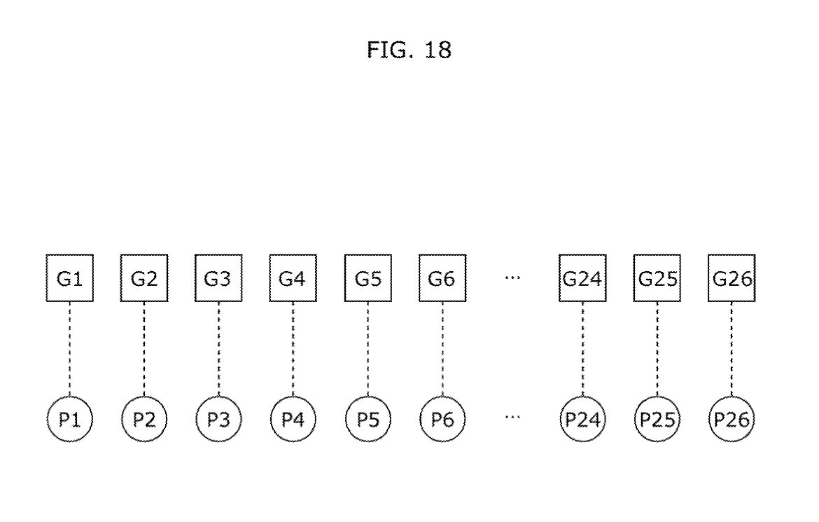

Next, the classifying unit 3 sets each of the content items as a single group (S13). Specifically, as shown in FIG. 18, the classifying unit 3 groups the content information items P1 to P26 into groups G1 to G26 as default. Here, FIG. 18 shows the result that the information classification device 1 assigns one group to each of the content items.

Then, the classifying unit 3 merges the groups of which distance therebetween is close to each other based on the calculation result in S12, and generates new groups (S14). Here, the classifying unit 3 repeats the following operations until the number of the merging groups equals the number that the number-of-groups information indicates; calculating the distance between each of the groups based on the values in the distance table, and merging two groups, of which distance therebetween is closest to each other, into one. For example, the distance D(Ga, Gb) between two groups Ga and Gb is obtained by Expression 1. Here, Expression 1 defines that the distance D(Ga, Gb) between the two groups Ga and Gb is the greatest distance of the distance Dx_y between a factor (content information item Px) included in a group Ga and a factor (content information item Py) included in a group Gb. The two groups Gx and Gy to be merged in the processing are obtained by Expression 2. In other words, the two groups are a pair of factors of which distance therebetween is the shortest (closest to each other) among the factors of the two groups Ga and Gb. In the pair, the Gx and the Gy are respectively the factors of the groups Ga and Gb. It is noted that the distance function expressed in Expression 1 for calculating the distance between the groups according to the embodiment of the present invention is known as the furthest neighbor method; however, the distance function shall not be limited to this. Other functions, such as the nearest neighbor method and the mean value method, may be used as far as the distance between the groups is defined based on the capturing location information items of the content items.

$$\begin{matrix}( Expression 1 ) & \\ D ( Ga , Gb ) = {max}_{Px ∈ Ga , Py ∈ Gb} Dx\_y & [ Math . 1 ] \\ ( Expression 2 ) & \\ \{ \begin{matrix}Gx & ( x = {argmin}_{a} D ( Ga , Gb ) ) \\ Gy & ( y = {argmin}_{b} D ( Ga , Gb ) )\end{matrix} & [ Math . 2 ]\end{matrix}$$

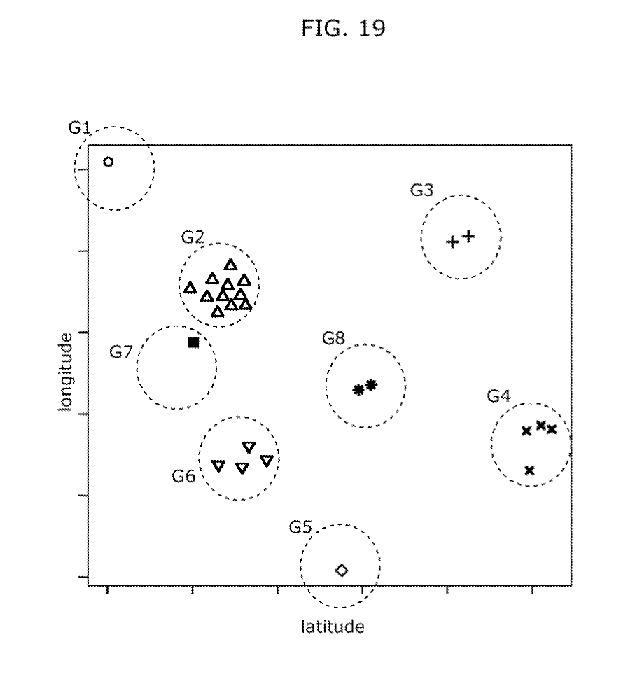

Next, the classifying unit 3 determines whether or not the number of the new groups generated in S14 equals the number indicated in the number-of-groups information (S15). In the case where the number of the new groups equals a predetermined number (S15: Y), the subsequent processing is executed. In the case where the number of the new groups is greater than the predetermined number (S15: N), the classifying unit 3 again executes the merging processing (S14). As a result, the classifying unit 3 provides the result of processing when the predetermined number is eight as shown in FIG. 19. Here, FIG. 19 shows the classification-in-progress of the content items carried out by the information classification device 1.

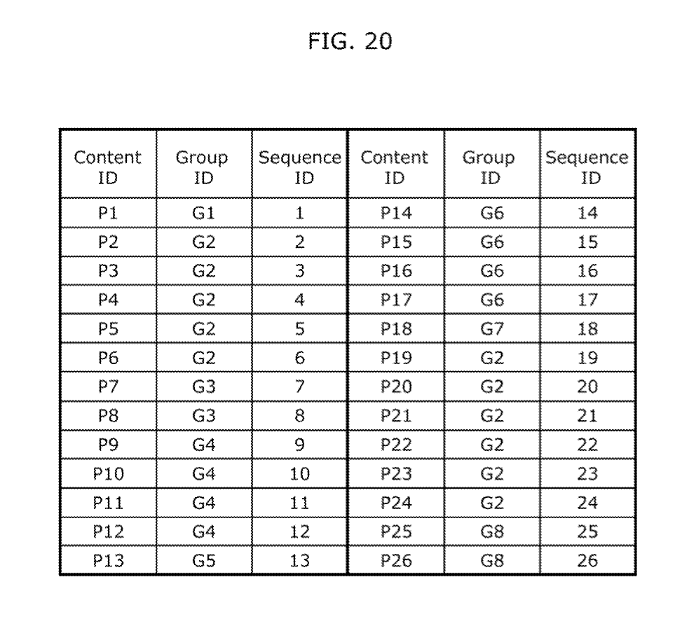

Next, with reference to the sequence numbers of the content items in each of the groups, the classifying unit 3 determines whether or not there is a group, among the groups, including content items of which temporal continuity is not ensured (S16). Specifically, the classifying unit 3 refers to the sequence IDs of the content items included in each of the groups G1 to G8, and determines whether or not all the groups consist of the content items having uninterrupted sequence IDs. Here, as seen in FIG. 20, the sequence IDs of the content items included in the groups G1 to G8 show that the content items included in the group G2 have interrupted sequence IDs. In other words, there is a group of which temporal continuity is not ensured (S16: Y). Thus, the processing proceeds to S17. Here, FIG. 20 exemplifies the case where the continuity of capturing times is not ensured in the progress of classifying the content items by the information classification device 1.

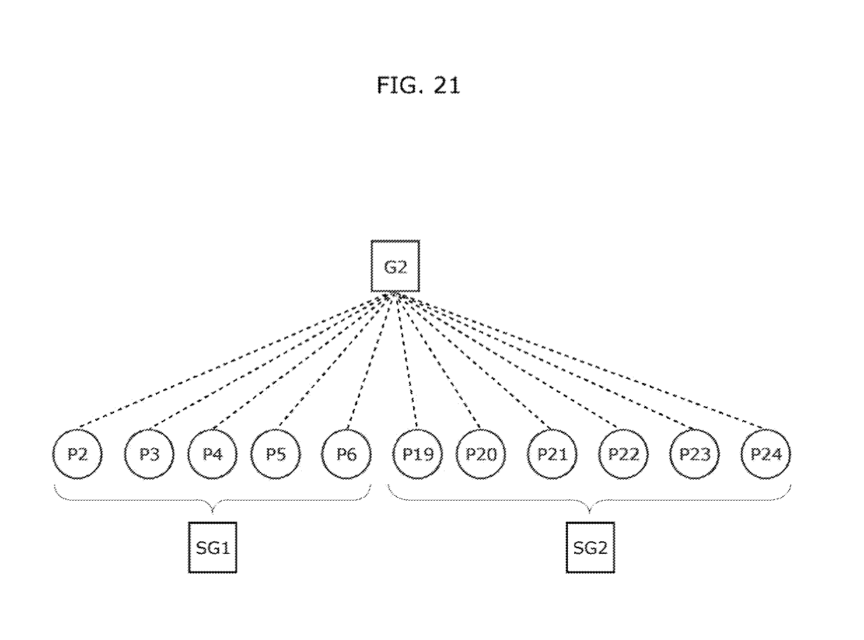

Next, in S17, the classifying unit 3 obtains the sequence numbers of the content items included in the group of which temporal continuity is not ensured (S111). Specifically, the classifying unit 3 obtains the sequence numbers of the content items included in the group G2. Then, based on the obtained sequence numbers, the classifying unit 3 divides the group G2 into two or more of the sub-groups of which temporal continuity is ensured (S112). Specifically, as shown in FIG. 21, the classifying unit 3 divides the content items included in the group G2 into a group of P2 to P6 (sequence IDs 2 to 6) and a group of P19 to P24 (sequence IDs 19 to 24). Hence, the classifying unit 3 generates the sub-groups SG1 and SG2 of which temporal continuity of the capturing times is ensured. FIG. 21 shows how the information classification device 1 adjusts a value of the distance table based on the sequence numbers of content items included in a group which does not maintain the continuity of capturing times.

Then, the classifying unit 3 adjusts the calculation result between the capturing locations in order to place the divided sub-groups distantly from each other for each of all the combinations of the sub-groups obtained in the previous processing (S113). Specifically, the classifying unit 3 updates the value Dw_z in the distance table using Expression 3 in order to increase the value D(SG1, SG2). In other words, Expression 3 shows that the classifying unit 3 places the sub-groups SG1 and SG2 distantly from each other by increasing the value Dw_z by α. Here, the Dw_z represents the distance between the SGw and the SGz which represent an element of the sub-groups SG1 and SG2, respectively. Here, the SGw and the SGz are a pair of factors of which distance therebetween is the greatest (farthest from each other) among the factors of the two sub-groups SG1 and SG2. In the pair, the SGw and the SGz are respectively the factors of the sub-groups SG1 and SG2. It is noted that in Expression 3, the distance function D for calculating the distance between the groups is expressed in Expression 1. As a matter of course, the distance function D may be replaced with other functions, such as the nearest neighbor method and the mean value method.

In the case where there are three or more sub-groups, the classifying unit 3 also updates the values of the distance table for the combinations of the sub-groups.

$$\begin{matrix}( Expression 3 ) & \\ Dw\_z = Dw\_z + α if \{ \begin{matrix}α > 0 , w = {arg}_{x} D ( SG 1 , SG 2 ) , z = {arg}_{y} D ( SG 1 , SG 2 ) \\ {arg}_{x} D ( SG a , SGb ) = {arg}_{x} ( {max}_{Px ∈ SGa , Py ∈ SGb} Dx\_y ) \\ {arg}_{y} D ( SGa , SGb ) = {arg}_{y} ( {max}_{Px ∈ SGa , Py ∈ SGb} Dx\_y )\end{matrix} & [ Math . 3 ]\end{matrix}$$

After that, the process returns to the processing in S17 in FIG. 7, repeating similar classification again. Then, the classifying unit 3 follows 513 to S17 and repeats generating groups until the temporal continuity of the content items included in each of the classified groups is ensured.

Finally, the classifying unit 3 stores the resulting classification information into the storage unit 2.

As described above, the classifying unit 3 classifies content items into groups each including the content items of which temporal weights are adjusted and capturing locations are geographically close to each other (S1).

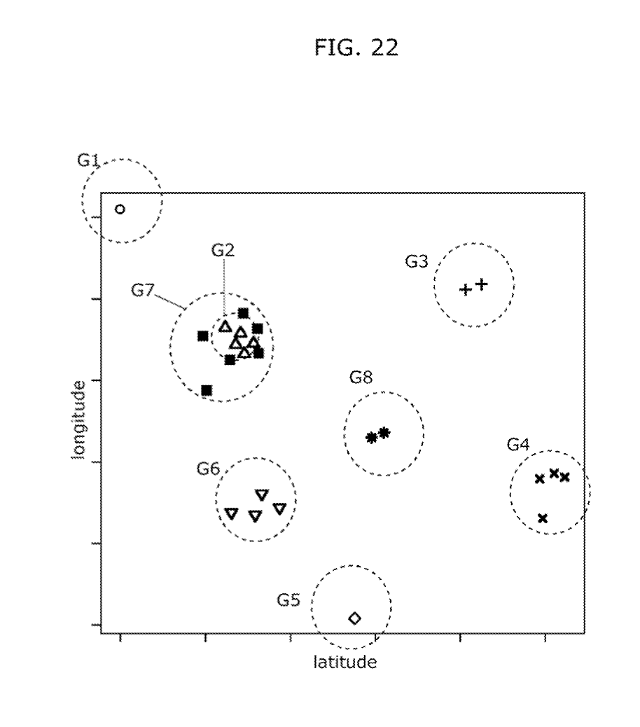

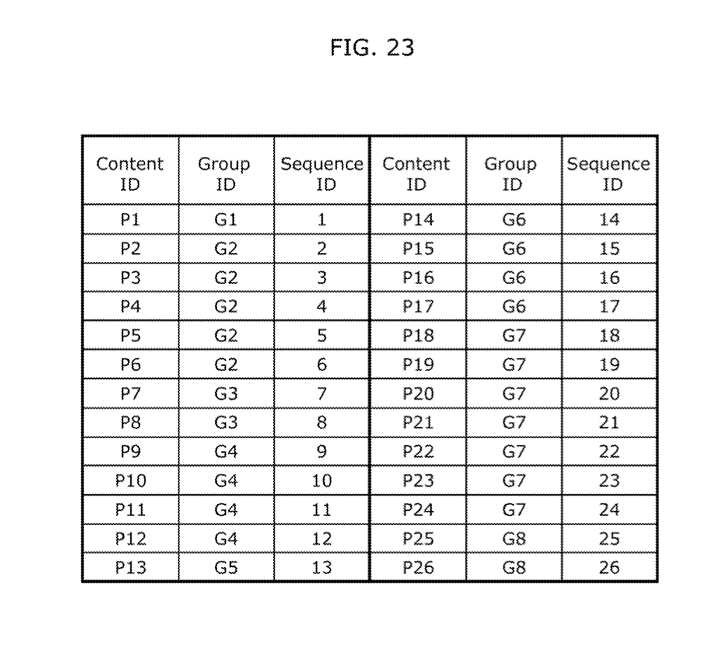

FIG. 22 shows the result of the classification when the content items are completely classified (S1). FIG. 23 shows the case where the continuity of capturing times is maintained when the content items according to the embodiment of the present invention are completely classified. The sequence IDs of the content items in included in G1 to G8 show that the sequence IDs are uninterrupted through the content items included in all the groups, maintaining the temporal continuity of the capturing times.

Then finally, the storage unit 2 stores each of the content items and the information of a group ID which the content item belongs to.

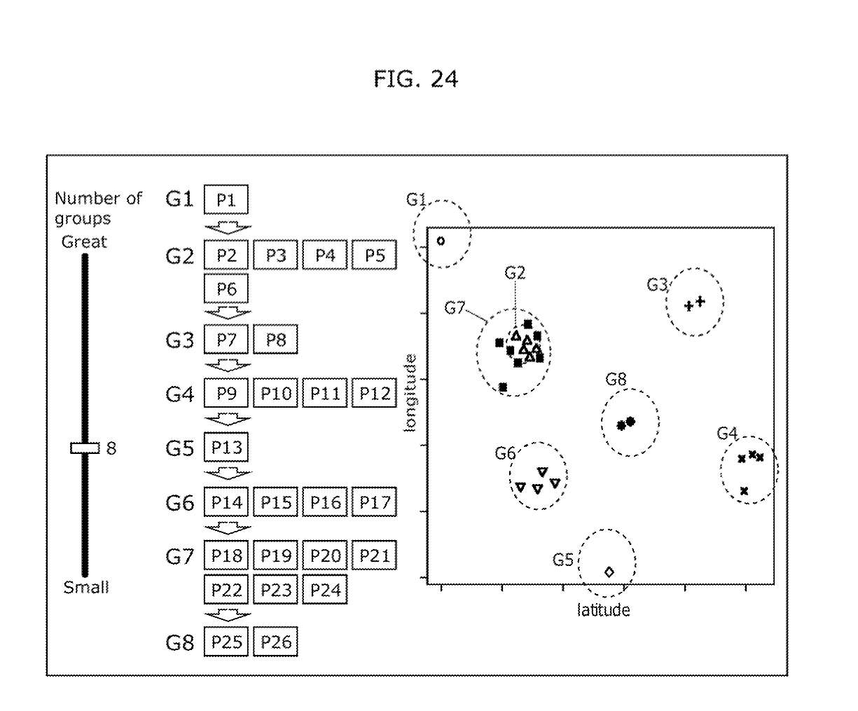

Thus, the classifying unit 3 classifies the content items (S1). The display unit 4 receives the content information and the classification information stored in the storage unit 2 as shown in FIG. 24, and displays the content information such that the content information is distinguishable for each group (S2). FIG. 24 exemplifies how the content items are displayed.

It is noted that FIG. 24 exemplifies the case where the display unit 4 displays all the content items; however, the case shall not be limited to this. Based on meta-information including the capturing information and the image information of the content items, the display unit 4 may display, as representative content items, only the content items of which level of importance is high in each group. Furthermore, FIG. 24 exemplifies the case where the display unit 4 displays a group ID for each group; instead, the display unit 4 may presume, based on the meta-information such as the capturing information, an event name which summarizes the group, and may display the event name instead of the group ID.

The present invention successfully provides an information classification device, an information classification method, and a program for classifying information items which can classify content items into groups so that each group includes the content items (i) that have temporal weights adjusted, freeing the user from adjusting the temporal weights himself or herself and (ii) that are captured geographically close to each other. The apparatus, the method, and the program can further ensure the temporal continuity of the capturing times.

(1-4. Others)

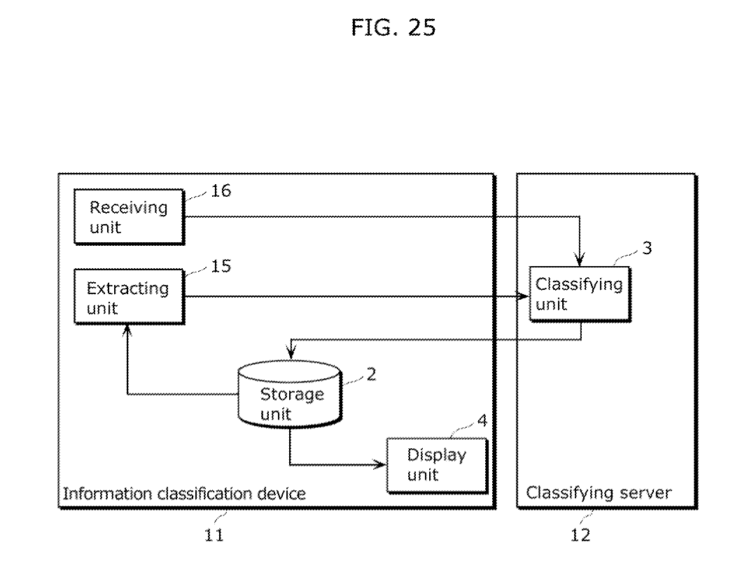

It is noted that the embodiment shows a structure of the information classification device 1 classifying the content items and displaying the classification result; however, the structure shall not be limited to the one described above. As shown in FIG. 25, for example, the information classification device 1 may be an information items classification system including a classifying serer 12 and its client; that is, an information classifying apparatus 11. FIG. 25 shows the structure of another information classification device according to the embodiment of the present invention. As shown in FIG. 25, for example, the classifying serer 12 may include the classifying unit 3, and the information classifying apparatus 11 may include the storage unit 2, the display unit 4, an extracting unit 15, and a receiving unit 16. In other words, among the storage unit 2, the classifying unit 3, and the display unit 4 included in the information classification device 1, the classifying server 12 is equipped with the classifying unit 3. In contrast, the client of the classifying server 12; namely the information classifying apparatus 11, does not include the classifying unit 3. Instead, the information classifying apparatus 11 includes the storage unit 2, the display unit 4, the extracting unit 15, and the receiving unit 16. Here, the extracting unit 15 extracts content information from the storage unit 2. The information classifying apparatus 11 may transmit to the classifying serer 12 the content information extracted from the extracting unit 15, receive only the classification result, and use the result for displaying content items on the display unit 4.

It is noted that the information classification device 1 of the present invention is typically provided in the form of a Large Scale Integration (LSI); namely, a semi-conductor integrated circuit. The structural elements of the information classification device 1 may be formed into a single chip, or part of the apparatus may be formed into a single chip. Here, the semi-conductor integrated circuit is referred to as LSI; instead, the circuit may also be referred to as IC, System-LSI, Super LSI, and Ultra LSI, depending on its degree of integration.

Furthermore, the means for circuit integration is not limited to the LSI, and implementation in the form of a dedicated circuit or a general-purpose processor is also available. In addition, it is also acceptable to use a Field Programmable Gate Array (FPGA) that is programmable after the LSI has been manufactured, and a reconfigurable processor in which connections and settings of circuit cells within the LSI are reconfigurable.

Furthermore, if integrated circuit technology that replaces LSI appears thorough progress in semiconductor technology or other derived technology, that technology can naturally be used to carry out integration of the constituent elements. Biotechnology can be applied to the integrated circuit technology.

Moreover, a semi-conductor chip into which the information classification device 1 of the present invention is integrated may be combined with a display for rendering an image to provide a rendering apparatus for various uses. The present invention successfully works as an information rendering unit for cellular phones, TVs, digital video decoders, digital camcorder, and car navigation systems. Other than the CRT display, the display to be combined with the semi-conductor chip may be, for example, a flat display such as a liquid crystal display, a plasma display panel (PDP), and an organic electro luminescent display, and a projection display such as a projector.

The information classification device of the present invention may be used for various purposes. In particular, the apparatus may be used as an information display unit for displaying a menu, a Web browser, an editor, an electronic program guide (EPG), and a map on battery-operated portable display terminals, such as cellular phones, portable music players, digital cameras and digital camcorders and on high-definition information display appliances such as TVs, digital video recorders, and car navigation systems.

### REFERENCE SIGNS LIST

1. and 11. Information classification device
2. Storage unit
3. Classifying unit
4. Display unit
12. Classifying server
15. Extracting unit
16. Receiving unit

1. An information classification device comprising:
a storage unit configured to store two or more content items and number-of-groups information, the content items each including (i) a capturing time information item indicating a capturing time of the content item and (ii) a capturing location information item indicating a capturing location of the content item, and the number-of-groups information indicating the number of groups into which the content items are classified; and
a classifying unit configured to classify the content items into the groups, the number of the groups being indicated in the number-of-groups information,
wherein said classifying unit is configured to:
generate, for each of the content items, a sequence information item indicating a sequence of capturing times of the content items, based on the capturing time information items;
generate, based on the capturing location information items, first groups, the number of the first groups being indicated in the number-of-groups information, and
said classifying unit is configured to:
check, based on the sequence information items, temporal continuity of the content items included in each of the generated first groups; and
in the case where there is a second group found among the generated first groups and including content items of which temporal continuity is not ensured, (i) divide the second group into two or more sub-groups each including a content item of which temporal continuity is ensured and (ii) adjust the first distance between the capturing locations of each of the content items so that the sub-groups become distant from each other and then repeat merging groups of which distance therebetween is close to each other, so as to classify the content items into the groups, the number of the groups being indicated in the number-of-groups information, and the second group being divided based on the sequence information item of the content item included in the second group.

2. The information classification device according to claim 1,
wherein said classification unit is configured to:
calculate a first distance between the capturing locations of each of the content items; and
set each of the content items to a group, and repeat merging groups of which distance therebetween is close to each other based on the calculated first distance so as to generate the first groups

3. The information classification device according to claim 2,
wherein, in the case where there is the second group found among the generated first groups and including the content items of which temporal continuity is not ensured, said classifying unit is configured to repeat merging groups of which distance therebetween is close to each other based on the adjusted first distance so as to regenerate the first groups, the number of the first groups being indicated in the number-of-groups information, and
until the temporal continuity of the content items included in each of the regenerated first groups is ensured, said classifying unit is configured to repeat regenerating the first groups from the group which is set to so as to classify the content items into the groups, the number of the groups being indicated in the number-of-groups information.

4. The information classification device according to claim 2,
wherein said classifying unit is configured to adjust the first distance by increasing a distance between capturing locations of the content items (i) included in the sub-groups and (ii) defining a distance between the sub-groups.

5. The information classification device according to claim 1,
wherein said classifying unit is configured to:
check, based on the sequence information items, temporal continuity of the content items included in each of the first groups; and
in the case where there is the second group found among the generated first groups and including the content items having interrupted sequence information item, determine that the second group among the generated first groups includes the content items of which temporal continuity is not ensured.

6. The information classification device according to claim 2,
wherein said classifying unit further includes a table which holds a value of the calculated first distance.

7. The information classification device according to claim 2,
wherein said classifying unit is configured to repeat generating new first groups from the group which is set to by merging groups of which distance therebetween is closest to each other based on the calculated first distance until the number of the first groups reaches the number indicated in the number-of-groups information, so as to generate the first groups into which the content items are merged, the number of the first groups being indicated in the number-of-groups information

8. The information classification device according to claim 1
wherein said information classification device further comprises a receiving unit configured to receive the number-of-groups information entered by a user.

9. The information classification device according to claim 1,
in the case where the temporal continuity of the content items included in each of the generated first groups is ensured, end the classification, determining the first groups as the groups.

10. An information classification device comprising:
a storage unit configured to store two or more content items and number-of-groups information, the content items each including (i) a capturing time information item indicating a capturing time of the content item and (ii) a capturing location information item indicating a capturing location of the content item, and the number-of-groups information indicating the number of groups into which the content items are classified; and
a classifying unit configured to classify the content items into the groups, the number of the groups being indicated in the number-of-groups information,
wherein said classifying unit is configured to:
generate a first group into which each of the content items is merged, based on a distance lying between capturing locations of each of the content items and calculated using the capturing location information items, the number of the content items being indicated in the number-of-groups information
check, based on the sequence information items, temporal continuity of the content items included in each of the generated first groups;
in the case where the temporal continuity of the content items included in each of the generated first groups is ensured, end the classification, determining the first groups as the groups;
in the case where there is a second group found among the generated first groups and including content items of which temporal continuity is not ensured, divide the second group into two or more sub-groups each including a content item of which temporal continuity is ensured; and
adjust the distance between each of two or more of the content items included in the sub-groups so that the sub-groups become distant from each other and then repeat merging groups of which distance therebetween is close to each other, so as to classify the content items into the groups, the number of the groups being indicated in the number-of-groups information.

11. An information classification method comprising:
storing two or more content items and number-of-groups information, the content items each including (i) a capturing time information item indicating a capturing time of the content item and (ii) a capturing location information item indicating a capturing location of the content item, and the number-of-groups information indicating the number of groups into which the content items are classified; and
classifying the content items into the groups, the number of the groups being indicated in the number-of-groups information,
wherein said classifying includes:
generating, for each of the content items, a sequence information item indicating a sequence of capturing times of the content items, based on the capturing time information items;
generating, based on the capturing location information items, first groups, the number of the first groups being indicated in the number-of-groups information, and
said classifying includes:
checking, based on the sequence information items, temporal continuity of the content items included in each of the generated first groups; and
in the case where there is a second group found among the generated first groups and including content items of which temporal continuity is not ensured, (i) dividing the second group into two or more sub-groups each including a content item of which temporal continuity is ensured and (ii) correcting the first distance between the capturing locations of each of the content items so that the sub-groups become distant from each other and then repeat merging groups of which distance therebetween is close to each other, so as to classify the content items into the groups, the number of the groups being indicated in the number-of-groups information, and the second group being divided based on the sequence information item of the content item included in the second group.

12. The information classification method according to claim 11,
wherein said checking temporal continuity of the content items included in each of the generated first groups further includes, in the case where the temporal continuity of the content items included in each of the generated first groups is ensured, ending the classification, determining the first groups as the groups.

13. A non-transitory computer-readable recording medium for use in a computer, said recording medium having a computer program recorded thereon for causing the computer to execute:
storing two or more content items and number-of-groups information, the content items each including (i) a capturing time information item indicating a capturing time of the content item and (ii) a capturing location information item indicating a capturing location of the content item, and the number-of-groups information indicating the number of groups into which the content items are classified; and
classifying the content items into the groups, the number of the groups being indicated in the number-of-groups information,
wherein said classifying includes:
generating, for each of the content items, a sequence information item indicating a sequence of capturing times of the content items, based on the capturing time information items;
generating, based on the capturing location information items, first groups, the number of the first groups being indicated in the number-of-groups information, and
said classifying includes:
checking, based on the sequence information items, temporal continuity of the content items included in each of the generated first groups; and
in the case where there is a second group found among the generated first groups and including content items of which temporal continuity is not ensured, (i) dividing the second group into two or more sub-groups each including a content item of which temporal continuity is ensured and (ii) correcting the first distance between the capturing locations of each of the content items so that the sub-groups become distant from each other and then repeat merging groups of which distance therebetween is close to each other, so as to classify the content items into the groups, the number of the groups being indicated in the number-of-groups information, and the second group being divided based on the sequence information item of the content item included in the second group.
